(19) United States
(12) Patent Application Publication
(10) Pub. No.: US 2009/0318305 A1
(43) Pub. Date: Dec. 24, 2009

(54) METHODS FOR SELECTIVELY CAPTURING AND AMPLIFYING EXONS OR TARGETED GENOMIC REGIONS FROM BIOLOGICAL SAMPLES

(76) Inventors: Xi Erick Lin, Atlanta, GA (US); Wenxue Tang, Atlanta, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 12/486,898

(22) Filed: Jun. 18, 2009

Related U.S. Application Data
(60) Provisional application No. 61/073,416, filed on Jun. 18, 2008.

(51) Int. Cl. C40B 30/04

(52) U.S. Cl. 506/9

(57) ABSTRACT

In one aspect, the present invention relates to a method for selectively capturing and/or amplifying exons or targeted genomic regions from biological samples. In one embodiment, the method includes the steps of obtaining DNA templates for the targeted genomic region, cloning the DNA templates into cloning vectors to form template DNA clones, constructing libraries of the template DNA clones that cover at least the targeted genomic regions, generating hybridization probes from the DNA template clones in the libraries, capturing the targeted genomic DNA regions by hybridizing the targeted genomic DNA samples (fragmented either mechanically or enzymatically) with the generated hybridization probes, and eluting the captured genomic fragments by using conditions for releasing and separating the bound DNA from the hybridization probes.

### CROSS-REFERENCE TO RELATED PATENT APPLICATION

This application claims priority to and the benefit of, pursuant to 35 U.S.C. §119(e), U.S. provisional patent application Ser. No. 61/073,416, filed Jun. 18, 2008, entitled “METHODS TO SELECTIVELY CAPTURE AND AMPLIFY ALL EXONS, ANY SUBSETS OF EXONS, OR ANY OTHER DESIRED REGIONS OF GENOMIC, MITOCHONDRIA AND OTHER FORMS OF DNA FROM ANY BIOLOGICAL SPECIES,” by Xi Erick Lin and Wenxue Tang, the content of which is incorporated herein in its entirety by reference.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference were individually incorporated by reference. In terms of notation, hereinafter, “(Author, Year)” represents the nth reference cited in the reference list. For example, (Margulies et al., 2005) represents the reference cited in the reference list, namely, Margulies E H, Vinson J P, Miller W, Jaffe D B, Lindblad-Toh K, Chang J L, Green E D, Lander E S, Mullikin J C, Clamp M (2005) An initial strategy for the systematic identification of functional elements in the human genome by low-redundancy comparative sequencing. Proceedings of the National Academy of Sciences of the United States of America 102:4795-4800.

### FIELD OF THE INVENTION

The present invention generally relates to capture and amplification of targeted genomic DNA regions, and more particularly to a method that utilizes the hybridization DNA and/or RNA probes generated from template DNA clones to selectively capture and amplify all exons, or any subsets of exons, or any other desired regions of genomic, mitochondria and other forms of DNA from any biological species including animalia, plantae, fungi, protista, archaea and eubacteria.

### BACKGROUND OF THE INVENTION

Deoxyribonucleic acid (DNA) sequencing on the scale of a few millions to billions of base pairs (bps) per experimental run is made available by recent technological advances (Margulies et al., 2005). Massively-parallel sequencing systems are now commercially available from at least three companies (e.g., 454 system offered by Roche; Illumina system offered by Illumina; SOLiD system offered by Applied BioSystems). The current sequencing capacity of some of the systems is sufficient for routinely performing de novo sequencing and resequencing of a significant portion of genome of many biological species including human and mice (Stephens et al., 2006). However, a major bottleneck for the successful implementation of widespread applications of the new technology has been in the front-end steps to selectively capture and enrich targeted exons or targeted intron regions scattered over the genomic, mitochondria and other forms of DNA, in a cost-effective manner. Selective capture and enrichment of specific regions of genomic, mitochondria and other forms of DNA from biological species have widespread applications.

Conventionally, the process for capture and amplification of targeted genomic DNA fragments is as follows:
(1) DNA is extracted from biological samples comprising nucleic acids.
(2) The extracted DNA is fragmented by various means including mechanical, ultrasonic or enzymatic approaches.
(3) Targeted DNA fragments are captured selectively by hybridizing DNA fragments with complimentary DNA and/or RNA probes.
(4) DNA fragments not bound to the hybridization probes are washed away first. DNA fragments bound to the hybridization probes are eluted in the next step under appropriate conditions.
(5) The captured DNA is used for downstream applications. If a larger quantity of the captured DNA is needed, polymerase chain reactions (PCRs) are performed to amplify the captured DNA fragments by using a pair of universal primers. The universal DNA primers of specifically-designed sequences are ligated to 5′- and 3′-ends of all DNA fragments, after either step (2) or step (4).

For any commercially-viable operation with the aim of capturing DNA fragments to be successful, the methods to generate and place the hybridization DNA and/or RNA probes on solid supporting materials or mixed in liquid solutions are the vital technologies for the entire process (used for the step 3 in the above described process). Specificity of the capture is determined by the DNA or RNA sequence of the hybridization probes. Selective capture of any desired regions of genomic and mitochondria DNA from any biological species requires a cost-effective and flexible way to reliably generate and verify massive amount of the hybridization probes. These DNA and/or RNA probes must have sequences precisely complimentary to the regions of interest in the genomic and mitochondria DNA of the biological species of interest. Capacity of the capture is determined by a combination of number and length of different probes available for use in the hybridizations. Longer-length probes require fewer probes to cover the same DNA region for capture. Flexibility of the capture is determined by the way the probes are generated and placed on either solid supporting materials or mixed in liquid solutions. These hybridization DNA and/or RNA probes should have the overall capacity and flexibility to selectively capture all exons, or any subsets of exons, or any other desired regions of genomic, mitochondria and other forms of DNA from any biological species. The specificity, capacity and flexibility have to be achieved in a cost-effective manner to be able to compete in the market. Thus, great technological and commercial relevance would be gained if methods of effectively solving all these challenges are available.

Therefore, a heretofore unaddressed need exists in the art to address the aforementioned deficiencies and inadequacies.

### SUMMARY OF THE INVENTION

In one aspect, the present invention relates to a method for selectively capturing and/or amplifying exons or targeted genomic regions from a biological sample. In particular, the present invention claims a novel way of making DNA and/or RNA hybridization probes from DNA clones. In one embodiment, the method includes the steps of obtaining DNA templates for the targeted genomic region, cloning the DNA templates into cloning vectors to form template DNA clones, constructing libraries of the template DNA clones that cover at least the targeted genomic regions, generating hybridization DNA and/or RNA probes from the DNA template clones in the libraries, capturing the targeted genomic DNA regions by hybridizing the targeted genomic DNA regions with the generated hybridization probes, and eluting the captured genomic DNA by using conditions for releasing the bound DNA from the hybridization probes. The elution conditions may include changes of temperature, changes of salt solution, or changes of pH of solutions.

In one embodiment, the DNA templates are obtained by reverse transcriptions from total RNA or mRNA from the biological sample. In another embodiment, the DNA templates are obtained by performing multiplex polymerase chain reactions (PCRs), or by gene synthesis of targeted genetic regions that contain DNA. In another embodiment, the DNA templates are corresponding to predetermined segments of mitochondria DNA, or the entire mitochondria DNA.

In one embodiment, the cloning step comprises the step of ligating the DNA templates into a cloning vector or plasmid. The purpose of cloning DNA templates is for easy storage, amplification, duplication and propagation of the template DNA material for later use.

In one embodiment, depending on the starting RNA materials, template DNA clones in the libraries contain full-length mRNA, open-reading frame of mRNA, or partial-length cDNA of the genes expressed by the biological sample. In another embodiment, the libraries of the template DNA clones represent the intron regions of interest, when the intron regions are amplified by either multiple PCRs or gene synthesis.

In one embodiment, the template DNA clones in the libraries made from cDNA by reverse transcriptions or PCR reactions are used to capture exons of the biological sample. In another embodiment, the template DNA clones in the libraries made from multiplex PCRs amplifying intron regions are used to capture intron regions of the biological sample. In yet another embodiment, the template DNA clones in the libraries made from mitochondria DNA are used to capture mitochondria DNA of the biological sample. The template DNA in the clones can be used directly as hybridization probes, or the templates themselves can be released from the plasmids by enzymatic digestion or PCR amplifications and used as hybridization probes.

In one embodiment, the template DNA clones in the libraries are organized in a format that is manipulable by a robotic system. The information of the template DNA clones is stored in a computerized database, the information including at least identity, generation date, persons who made the clones and location of each clone.

In one embodiment, the constructing step comprises the steps of examining the quality and the completeness of the template DNA clones in the libraries, and monitoring and maintaining the quality of the template DNA clones in the libraries for long-term uses. The examining step comprises the step of confirming the DNA sequence of each clone in the libraries, and comparing the DNA sequences of the clones with the reference DNA sequences of the targeted genes or targeted genomic regions of the biological sample so as to check the completeness and the sequence accuracy of the clones in the libraries.

In one embodiment, the hybridization probes are generated by releasing DNA fragments hosted in the cloning vectors or plasmids with the use of restriction enzymes to digest the template DNA fragments out of the cloning vectors or plasmids. In another embodiment, the hybridization probes are generated by PCR amplifications using the common primer pair sequences contained in the cloning vectors or plasmids in multiple cloning sites. In yet another embodiment, the cloning vectors or plasmids are directly used as the hybridization probes without enzymatically cutting the template probes out or PCR amplify the DNA templates. In a further embodiment, the hybridization probes are generated by in vitro transcriptions from DNA template clones in libraries. In an alternative embodiment, the hybridization probes are generated by obtaining cDNA or cRNA of genes by using in vitro reverse transcriptions of the DNA templates in the library.

In one embodiment, the capturing step comprises the step of fixing the hybridization probes on surfaces of a solid supporting material or mixing the hybridization probes in a liquid solution.

In another aspect, the present invention relates to a method for selectively capturing and/or amplifying targeted genomic regions from a biological sample. The targeted genomic regions comprises exons, subsets of exons, or desired regions of genomic, mitochondria and other forms of DNA from the biological sample including animalia, plantae, fungi, protista, archaea and/or eubacteria.

In one embodiment, the method includes the steps of providing libraries of template DNA clones that cover at least the targeted genomic regions, generating hybridization probes from the DNA template clones in the libraries, and capturing the targeted genomic DNA regions by hybridizing the targeted genomic DNA regions with the generated hybridization probes.

In one embodiment, the providing step comprises the steps of obtaining DNA templates for the targeted genomic regions, cloning the DNA templates into cloning vectors to form template DNA clones, constructing libraries of the template DNA clones that cover at least the targeted genomic regions, and examining the quality and the completeness of the template DNA clones in the libraries.

Additionally, the method may include the step of eluting the captured genomic regions by using conditions for releasing the bound DNA from the hybridization probes.

In a further aspect, the present invention relates to a kit for capturing and/or amplifying targeted genomic regions from a biological sample. In one embodiment the kit has libraries of template DNA clones that cover at least the targeted genomic regions, wherein the template DNA clones are formed by cloning the DNA templates obtained from the targeted genomic regions into cloning vectors, hybridization probes generated from the DNA template clones in the libraries, and means for hybridizing the targeted genomic DNA regions with the generated hybridization probes so as to capture the targeted genomic DNA regions.

In one embodiment, the hybridizing means comprises a solid supporting material having one or more surfaces on which the hybridization probes are placed for hybridization of the hybridization probes and the genomic DNA fragments, or a solution with which the hybridization probes are mixed for hybridization of the hybridization probes and the genomic DNA fragments.

In one embodiment, the libraries of the template DNA clones are stored in and managed by a computerized database.

Furthermore, the kit has means for eluting the captured genomic regions, and/or means for detecting the eluted genomic fragments/regions.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, wherein:

FIG. 1 shows a flow chart of a method for selectively capturing and/or amplifying exons or targeted genomic regions from biological samples according to one embodiment of the present invention;

FIG. 2 shows a confirmation of the eluted gDNA after capturing gDNA fragments according to the method of the present invention, where panels A) and B) are results from capture experiments designed to capture GJB2 & MYO7A, respectively. DNA samples loaded in each lane of the electrophoresis gel are: lane 1: salmon sperm DNA (as a negative control); lane 2: human gDNA fragments, amplified by PCR with primers for detecting Cx26 gene; lane 3: Repeat with a second human gDNA sample, similar to lane 2; lane 4: water, negative control for PCR amplification of Cx26 PCR primers; lane 5: gDNA without fragmentation treatment and DNA capturing process, positive control for PCR amplification with Cx26 PCR primers used in experiments; lane 6: salmon sperm DNA eluted, primers for MYO7A used (another negative control); lane 7: human gDNA eluted, primers for MYO7A used (another negative control); lane 8: the second human gDNA sample eluted, primers for MYO7A used for PCR amplification (another negative control); lane 9: negative control of PCR amplification directly from water; lane 10: positive control using un-digested human gDNA without running through the DNA capture process; lane A: human gDNA eluted after capturing by our method, primers for MYO7A used for the PCR amplification; lane B: salmon sperm DNA eluted after capturing by our method, primers for MYO7A used for PCR (used as a negative control); lane C: water, negative control; and lane D: gDNA without fragmentation treatment and DNA capturing process, positive control for PCR amplification with the MYO7A primers. The relative positions of the PCR primers used in experiments are illustrated by diagrams on top of the image.

FIG. 3 shows another confirmation test of the eluted gDNA captured by the invented method. Bsu36I digested human gDNA from before capture (about 10% of total amount) and after elution when 90% of the DNA samples are processed by our method was examined by Southern blots. Results show a single band in pre- and post-capture samples both at the expected size of about 2400 bps (pointed by an arrow). Comparing the densities of the bands in the Southern blots gives an estimate of capture efficiency for gDNA by the method of the present invention at about 56%.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Additionally, some terms used in this specification are more specifically defined below.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

In accordance with the purposes of this invention, as embodied and broadly described herein, this invention, in one aspect, relates to a method for selectively capturing and/or amplifying all exons, or any subsets of exons, or any other desired regions of genomic, mitochondria and other forms of DNA from any biological species. The biological species include animalia, plantae, fungi, protista, archaea, eubacteria, and the like. The method in one embodiment is implemented by generating and utilizing hybridization DNA and RNA probes.

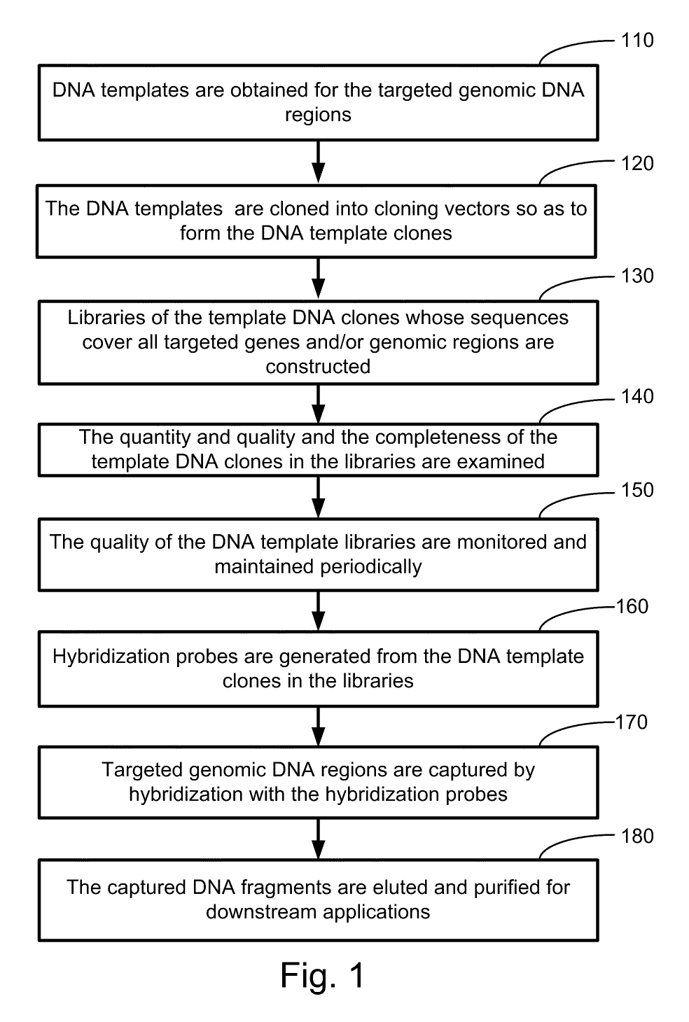

Referring to FIG. 1, a flow chart of the method for selectively capturing and/or amplifying exons or targeted genomic regions from biological samples is shown according to one embodiment of the present invention.

At step 110, DNA templates are obtained for the targeted genomic DNA regions. In one embodiment, these templates for exons are obtained by reverse transcriptions from total RNA or mRNA from a particular biology species of interest. In order to obtain a complete collection of total RNA or mRNA expressed by a particular biology species that contain the targeted exons, samples should be acquired from different organs and tissues from the particular biology species. Also for the completeness of the collection of expressed RNA, the samples should be collected at various developmental stages.

As alternative methods to generate the templates (especially those in the non-coding intron regions), the desired exon DNA can also be selectively amplified by performing multiplex polymerase chain reactions (PCRs), or by gene synthesis method for any DNA sequences of choice.

If introns are targeted genomic DNA regions for capture, these intron regions will need to be amplified by multiplex PCRs from genomic DNA or from bacterial artificial chromosome (BAC) clones that host the targeted intron regions.

Because of the relatively short length of mitochondria DNA, the entire mitochondria DNA or large segments of them can be directly used as the templates for generating probes by performing multiplex PCRs or by gene synthesis method.

At step 120, the DNA templates for generating hybridization probes are cloned into cloning vectors for storage, propagation and other molecular manipulation purposes. The DNA templates obtained in step 110 are ligated into cloning vectors or plasmids. The cloning vectors or plasmids can be any cloning vectors or plasmids used for molecular cloning purposes, e.g., constructing cDNA libraries.

Once ligated into a particular cloning vector or plasmid, the DNA templates obtained in step 110 are handled by typical molecular cloning techniques for the purposes of storage, propagation, further manipulations such as subcloning and preparations for making larger quantities of clones and other.

According to the present invention, for the purposes of generating hybridization capturing probes, it is not necessary to achieve expressible cDNA clones (those that can be transfected into cell lines to make the full-length protein for the particular gene) and 100% error-free sequence of the clones is not required. This lower requirement is expected to greatly speed up the efficiency for collecting the DNA probe templates and DNA clones necessary for the entire process of capturing gDNA fragments.

At step 130, libraries of the template DNA clones that cover all targeted genes and/or genomic regions are constituted. In one embodiment, depending on the starting RNA materials, the libraries of cDNA clones representing either full-length RNA, or open-reading frame RNA, or partial-length cDNA of the genes expressed by the biological species of interest are obtained. For example, in the case of which intron regions are amplified by multiple PCRs in step 110, the libraries of clones representing the intron regions of interest are obtained.

According to embodiments of the present invention, clones in the libraries made from cDNA by reverse transcriptions or by gene synthesis methods are used to capture exons. Clones in the libraries made from multiplex PCRs amplifying intron regions or by gene synthesis methods are used to capture intron regions. Clones in the libraries made from mitochondria DNA are used to capture mitochondria DNA of the particular biological species.

For the purpose of long-term and consistent management, the large quantity of DNA clones is organized in a format that is able to be manipulated by a robotic system. For example (but not limited to these formats), clones can be stored in multiple well plates, e.g., 96-well, or 384-well plates, or other plates with greater numbers of wells in them. In one embodiment, a computerized database is used to help managing the collections of probes in the DNA clones.

At step 140, the quality and the completeness of the template DNA clones in the libraries are examined: The DNA sequence of each clone in the libraries needs to be confirmed by sequencing. Clones that contain DNA sequences either too short, having too many errors, or not from the intended targets are discarded. In one embodiment, the confirmed DNA clones are transferred to new plates for further uses. Identities, locations of the clones in the storage plates and other information of the clones are stored in and managed by a computerized database.

The accuracy and completeness of the clones in the libraries are checked by comparing DNA sequences of obtained clones with the reference DNA sequences of targeted genes or targeted genomic regions of the particular biological species. The reference DNA sequences for any biological species can be obtained either from public sources or acquired by de novo sequencing of that particular biological species if they are not already available.

In one embodiment, steps 110-140 are repeated until a complete collection of cDNA clones that represent all the targeted genes of choice, or contain all genes expressed by the particular biological species, or the intron regions of interests are obtained.

For those genes still missing after many repeats of steps 110-140, alternative steps are taken to directly amplify the DNA regions of interests by PCR reactions or by utilizing gene synthesize methods. Additionally, the DNA clones of many genes (either full-length or open reading frame) of some species are also commercially available now on the open market, which can also be used as an alternative source for obtaining DNA clones.

At step 150, the quantity and quality of the template DNA clones in the libraries is monitored and maintained for long-term uses: In one embodiment, the DNA libraries can be duplicated robotically or manually as needed. With proper maintenance, periodic quality monitoring and problem solving, the clones in the libraries containing exon and/or intron regions of particular biological species for any desired target genes and genomic regions can be used as stable sources for generating hybridization probes indefinitely.

At step 160, hybridization probes are generated from the DNA template clones in the libraries: The clones in the DNA libraries are grown to achieve desired quantity. The hybridization DNA or RNA probes that are generated from the DNA templates ligated into the cloning vectors and/or plasmids are used for capturing genomic and mitochondria DNA fragments.

In one embodiment, the hybridization probes are generated by releasing DNA fragments hosted in the cloning vectors and/or plasmids with the use of restriction enzymes to digest the template DNA fragments out of the cloning vectors and/or plasmids.

In another embodiment, the hybridization probes are generated by PCR amplifications using the common primer pair sequences contained in the cloning vectors and/or plasmids, usually in the multiple cloning sites. These reactions are setup either manually or robotically if the numbers of the hybridization probes need to be generated are too large to be handled efficiently by manual operations. The PCR reactions are setup and carried out in each well of the multi-well plates. In one embodiment, the PCR reactions of multiple plates are carried out in the same thermal cycler simultaneously for many clones in the libraries.

In yet another embodiment, the hybridization probes harbored in the cloning vectors/plasmids are generated by directly using these vectors or plasmids without enzymatically cutting the probes out or PCR amplify the DNA fragments. The vectors or plasmids hosting DNA probes can be grown to desired quantity and purified. The purified vectors or plasmids are subjected to conditions that make them single-stranded, and are then directly fixed on solid supporting materials or mixed in liquid solution, to be used as hybridization probes.

In an alternative, RNA hybridization probes are generated by in vitro transcriptions from DNA template clones contained in the libraries. These can be conventional RNA probes or RNA probes incorporating biotinylated nucleotides that enhance the manipulability of later steps.

In practice, before the probes are used for hybridization, these probes (DNA fragments enzymatically cut from cloning vectors or plasmids, or PCR amplicons in each well, or vectors or plasmids) need to be purified. The amount of purified DNA probes corresponding to each target need to be quantified.

In one embodiment, the hybridization probes are generated by obtaining cDNA or cRNA of genes by using in vitro reverse transcriptions from the template DNA contained in the libraries obtained above. cDNA or cRNA with the length ranging from partial full length to full-length of the genes can be used for these purposes. If cDNA or cRNA only covers partial length of the gene, especially for those long genes, multiple cDNAs or cRNAs need to be used to ensure that the combined coverage of these cDNA probes span over the entire length of the gene. The use of either a single full-length cDNA or multiple partial-length cDNAs spanning the entire exon regions of the gene ensures capture of entire sets of exons for that particular gene.

In practice, these cDNAs or cRNA may contain small number of sequence errors, as long as the effect of these errors are not accumulated to a degree that is sufficient to severely degrade the binding specificity and efficiency in the hybridization step for capture. The less than 100% error-free rate requirement will reduce costs for probe generating steps.

At step 170, the targeted genomic DNA regions are captured by hybridization and elution.

According to the present invention, appropriate amount of DNA/RNA probes obtained by any one of the above method can be used as hybridization probes for capturing of targeted gDNA regions. The principle is to use the saturating concentration of the hybridization DNA/RNA probes to ensure efficient captures. Double-stranded probes are subjected to conditions that make them single-stranded before and/or during the process of placing them on solid supporting materials, or mixing them in liquid solution. Single-stranded RNA probes generated by in vitro transcriptions are used directly for hybridization.

The DNA hybridization probes are usually placed on solid supporting materials by the following methods, or a combination of them: (a) the probes are spotted on glass slides by using any conventional genechip arrayers or genechip printers, and (b) the probes are placed on solid supporting materials manually.

The solid supporting materials include, but not limited to, glass slides, a glass slides coated with avidin, streptavidin or any other coatings suitable for DNA binding or rejections, glass beads without any coating, glass beads coated with avidin, streptavidin or any other coatings for DNA binding or rejections, any film membranes which are conventionally used for Southern or Northern or Western blot hybridizations, any film membranes which are conventionally used for Southern or Northern or Western blot hybridizations coated with avidin, streptavidin or any other coatings, multiple-well plates either coated or not coated with avidin or streptavidin.

Another way to utilize the hybridization probes harbored in the cloning vectors/plasmids is to directly use these vectors/plasmids without enzymatically cutting the probes out or PCR amplify the DNA fragments. The vector/plasmids hosting the DNA probes can be grown to desired quantity and purified. The vectors/plasmids containing DNA probes for targeted genomic regions are used as the hybridization probes directly by fixing them on solid supporting materials as single-stranded DNA.

In one embodiment, to attach DNA probes more firmly to the solid supporting materials, baking and/or UV cross linking may be used after they are placed.

In one embodiment, the hybridization probes can be mixed in hybridization solutions for capturing reactions in liquid phase, without first fixing these probes on a solid material.

After hybridization, captured genomic regions are eluted by using appropriate conditions that release the bound DNA from the probes at step 180. The conditions include, but not limited to, change of temperature, change of salt concentration, and/or change of pH of solutions. The released DNAs are collected (amplified if necessary) for further uses.

One aspect of the present invention provides a kit for capturing and/or amplifying targeted genomic regions from a biological sample. In one embodiment the kit has libraries of clones containing template DNA probes that cover the targeted genomic regions of interest, wherein the template DNA clones are formed by cloning the DNA templates obtained from the targeted genomic regions into cloning vectors, hybridization probes generated from the DNA template clones in the libraries, and means for hybridizing the targeted genomic DNA regions with the generated hybridization probes so as to capture the targeted genomic DNA regions.

Furthermore, the kit has means for eluting the captured genomic fragments (releasing and separating them from hybridization probes), and means for detecting the eluted genomic fragments of their identities.

In one embodiment, the hybridizing means comprises a solid supporting material having one or more surfaces on which the hybridization probes are placed for hybridization with the hybridization probes for the targeted genomic DNA regions, or a solution with which the hybridization probes are mixed for hybridization containing both the hybridization probes and the genomic and/or mitochondria DNA fragments.

In one embodiment, the libraries of the template DNA clones are stored in and managed by a computerized database.

Without intent to limit the scope of the invention, exemplary methods and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention.

The following exemplary experiment data demonstrates that targeted genomic DNA (gDNA) fragments are captured selectively by the invented methods with high efficiency. The key idea is to use cDNA-probe-based approach as a low-cost alternative to the high-density oligo-based genechip method. To test the specificity in capturing gDNA fragments according to the methods of the present invention, human gDNA (50 μg) was digested by a restriction endonuclease (HindII) digestion. The gDNA fragments were subsequently captured by the invented method and characterized accordingly.

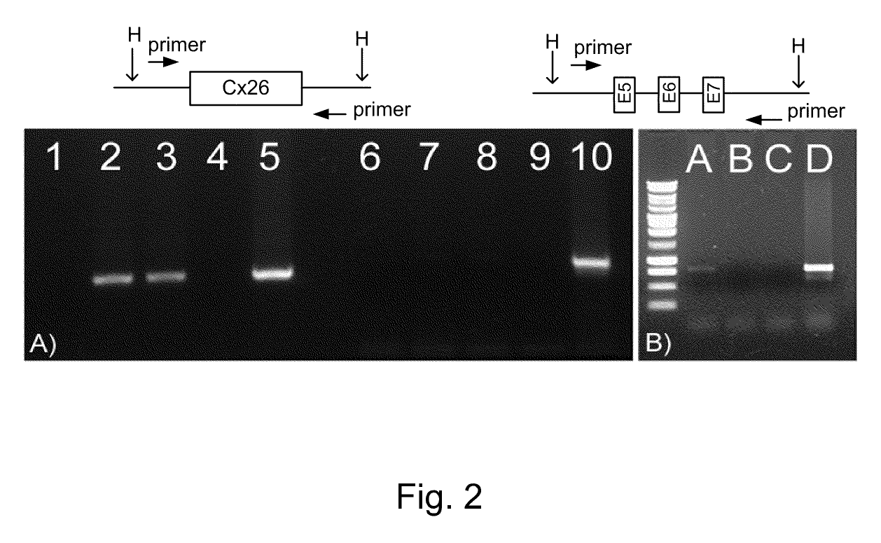

In this exemplary experiment, two cDNA capturing probes were tested. One was the cDNA probe for capturing the coding sequence of GJB2 that codes for connexin26 (Cx26) protein, the results of which are presented in FIG. 2A. The other was designed to capture part of MYO7A (exons 5 to 7) that codes for the human myosin7a protein, which the results are presented in FIG. 2B. HindII-digested gDNA was captured and eluted. First specific PCR amplifications with primer pairs, the design of which are shown in the top diagrams of the FIG. 2, were used to test the capture specificity. Positive samples were from human gDNA after capturing by the invented method, shown in lanes 2 and 3 in FIG. 2A, and a positive control shown in lane 5 in FIG. 2A. The human gDNA in lane 5 was used without any processing. All the samples generated clear bands with the expected size. Eluted DNA from negative controls (DNA samples from Salmon sperm or PCR directly from water, shown by lanes 1 and 4 in FIG. 2A, respectively) didn't generate any band. To test the specificity of gDNA capture, the captured and eluted DNA was PCR-amplified with a primer pair designed for exons 5-7 of MYO7A and the results were all negative, as shown by lanes 6-8 in FIG. 2A. Lane 9 is another negative control of PCR directly from water. Positive control using un-digested human gDNA without processing by the invented method yielded a clear band, shown by lane 10 in FIG. 2A, with the expected size. These results suggested that the gDNA captured by the invented method for the GJB2 (coding for Cx26 protein) gene enriched the intended target in gDNA fragments that specifically contained the GJB2, but not other regions that were not in the targets (e.g., MYO7A).

To test whether the primer pairs designed for amplifying MYO7A, shown in the diagram on top of FIG. 2, from gDNA is able to generate positive results, HindII digested gDNA fragments were captured by the invented method for the exon5 to exon7 of MYO7A. Both the captured and eluted human gDNA fragments (lane A in FIG. 2B) and positive controls (lane D in FIG. 2B, which is directly amplified by PCR from undigested human gDNA) generated clear bands at the expected size. In contrast, PCR amplifications from salmon sperm DNA after capture (lane B in FIG. 2B) and directly from water (lane C in FIG. 2B) yielded negative results.

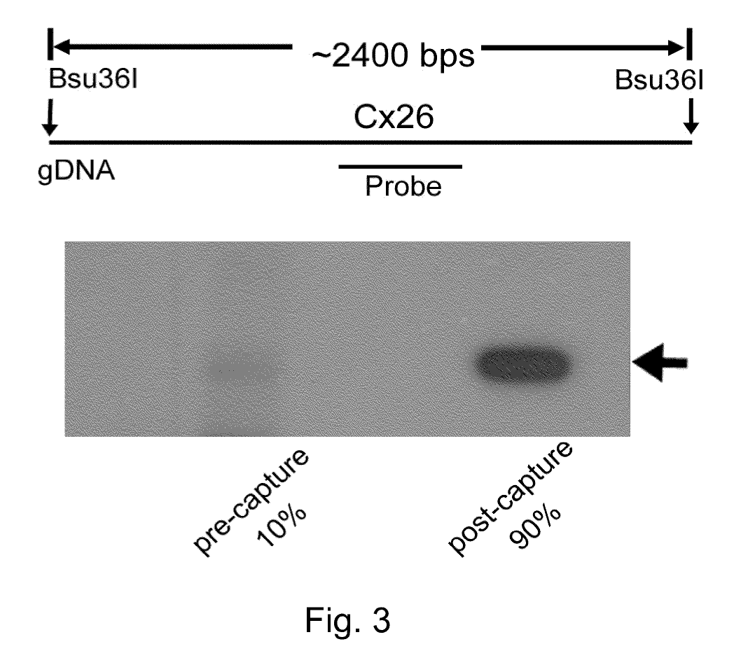

To determine the capture efficiency of the method of the present invention, gDNA was first digested with Bsu36I. Ten percent (10%) of the total amount of digested gDNA was used as pre-capture control sample. The other 90% of the gDNA sample was subjected to the capture by the invented method designed to capture GJB2 (exon2 of the Cx26). DNA from before capture and after elution was examined by Southern blots, which showed a single band in pre- and post-capture samples both at the expected size of ˜2400 bps, as shown by an arrow in FIG. 3. Comparing the relative density of the two bands suggested that the capture efficiency of the invented method was 56% for human gDNA samples. Thus, data presented here demonstrated that the invented method is able to capture targeted exons from human genomic DNA, with high specificity and efficiency.

### ADVANTAGES OF THE INVENTION

To date, the most successful methods for the purpose of selective capturing thousands of exons or any number of targeted exons and genomic regions simultaneously are by hybridizing genomic DNA (gDNA) fragments to high-density oligo genechips, and subsequent releasing captured DNA fragment by elution (Albert et al., 2007; Okou et al., 2007; Porreca et al., 2007; Gnirke et al., 2009). In the prior art, the bait probes needed for capturing genomic DNA are DNA oligos synthesized in situ on high-density genechips. In contrast, according to the present invention, the bait probes for capturing targeted regions of the genomic DNA are generated from a library of cDNA or other kinds of DNA templates. The approaches used in the prior art have following disadvantages comparing to the invented methods:

(1). Manufacture of high-density oligo genechips needs highly-expensive and specialized genechip manufacturing machines. However, the invented methods need no such specialized machines, thereby significantly reducing costs of operations that allow widespread applications of captured DNA fragments, such as next-generation sequencing systems.

Currently, only a few companies possess the core-technology for manufacturing the high-density oligo genechips. Large capital and operational scale are also needed to run the oligo synthesizing machines for on-site synthesis of large numbers of oligo probes on the high-density microarray genechips. However, the methods according to the present invention enables large numbers of small-scale laboratories, companies, hospitals and other users equipped with conventional equipment around the world to perform large scale gene capture and/or capture of selectively-targeted set of genes (or genomic regions) for genetic, diagnostic and other analyses. The methods are especially suited for selective capture of highly-selective set of targeted genes, such as genes related to a particular disease, or a particular set of related diseases, or genetic markers that may results in increased susceptibility to diseases. In those applications usually a set of few hundreds of genes are targeted, which makes the approach of using cDNA template library especially amenable for practical manipulations.

(2). The use of short probes on the high-density microarray limits the efficiency and specificity of capturing DNA fragments. However, according to the present invention, the approach of using long cDNA template for generating bait probes increases the specificity and efficiency of capture for DNA fragments.

Oligo hybridization probes synthesized on-site by a photolithographic process are used to produce the hybridization bait probes placed on high-density microarray genechips (Albert et al., 2007; Okou et al., 2007; Porreca et al., 2007; Gnirke et al., 2009). For the purpose of capturing targeted genomic DNA fragments, the length of oligo probes has been purposely increased to about 80 base pairs (bps) or even longer (Gnirke et al., 2009) to ensure a more efficient capture (Albert et al., 2007; Okou et al., 2007; Porreca et al., 2007). To synthesize even longer probes is technically challenging and the genechips are more expensive to manufacture.

It is known that high-density oligo microarray captures contain about half of the DNA fragments not from the intended targets (Albert et al., 2007; Okou et al., 2007; Porreca et al., 2007). The use of short-length oligo DNA probes is partially responsible for the contamination problem.

In contrast, according to the present invention, these problems are alleviated by using full-length cDNA probes or long-length DNA probes that are much longer than the DNA oligo probes used in the prior art (Albert et al., 2007; Okou et al., 2007; Porreca et al., 2007). By utilizing the bait probes that are typically in the range of 2,000 bps, the specificity of the capture during hybridization step is improved by allowing the use of more stringent hybridization conditions. Long DNA probes used by the invented methods also ensure that highly stringent hybridization conditions can be used under which targeted DNA fragments are still able to bind to the probes. These highly stringent hybridization conditions should reduce nonspecific bindings, thereby reducing non-specific captures of non-targeted genomic regions.

Since expressible and 100% error-free DNA clones are not required for the purposes of capturing genomic and mitochondria DNA fragments, the amount of work needed to obtain DNA libraries representing complete set of genes expressed by any particular biological species is significantly reduced. In additional, full-length cDNA or open-reading-frame cDNA clones of many genes of some species are already available commercially on the open market. By directly purchasing these clones from commercial sources, the time needed to finish steps of constructing DNA probe libraries can be accelerated even more.

(3). Small spot size on the high-density microarray genechips used in the prior art imposes a significant limit on the capacity and completeness of the capture. However, according to the present invention, the approach enables the use of much larger spots to be placed on solid surfaces, or even performing hybridization in solutions with the use of cRNA probes.

For 500 k-probe high-density microarray genechips, typical spot size of each feature is about 15×18 μm (or 270 μm²) (Cutler et al., 2001). Higher density and larger spot size are two incompatible demands. For the most advanced microarray genechips currently on the market, 2.1 million probes are assembled on one genechip which have even smaller spots for each feature. Price for these ultra-high density genechips is also much higher. The small spot size reduces the capacity of capture, especially when larger quantity of genomic and mitochondria DNA are needed to be used as materials for downstream applications.

In the invention, DNA probes are fixed on glass slide with a much lower density, or they are fixed on the surface of glass beads, or these probes are fixed on the surface of the wells in the multi-well plates. Probes spotted by conventional arrayers will have a much larger surface area for each probe on glass slide, since density of the probes are much lower. Spot sizes on arrays produced by conventional arrayers are adjustable, and are typically 50 times bigger than the spots produced on 500 k microarray genechips. The use of glass beads, film membrane and multi-well plates can even give larger surface areas for hybridization probes. All these factors contribute to higher capacity for DNA capture.

In case that RNA hybridization probes are used to capture genomic DNA fragments, these probes can be used in liquid solutions directly without first fixing them on solid materials. The capacity for DNA capture performed in liquid phase will be even larger.

The saturating amount of DNA fragments each genechip is able to capture becomes an important issue when cost is one important consideration, as is always the case for any successful commercial operations. For example, minimal starting DNA quantity for the two commercially available massively-parallel DNA sequencing systems (SOLiD system and the Illumina system) is 0.1 μg. Human exons are about 2% of the total genome. For 40-100 μg of genomic DNA typically obtainable from 2 milliliter of human saliva or blood samples, of which 0.8-2 μg should be the exon regions. This is at least 8 times higher than the minimal quantity of genomic DNA for downstream genetic analysis. Therefore, how to capture as completely as possible of all genomic DNA and mitochondria fragments is critical for successful analysis of complete set of exons in as few rounds of machine operations as possible. Since material cost for each machine run is about $8,000-10,000, fewer machine runs will significantly lower the operation cost.

Since larger quantity of targeted genomic DNA can be captured by the invented methods, therefore PCR amplifications prior to sending the samples to the massively-parallel sequencing machines may not be necessary in many cases. Avoiding excessive PCR steps is critical for sequencing applications because differences in relative quantities among different genes after PCR amplifications typically are at least 1000 fold. This creates sampling biases for next-generation sequencing based on clonal single molecular sequencing approach to cover all the intended targets.

(4). Capacity of high-density microarray genechips used by prior art is not enough to capture the whole collection of human exons (human exome) on a single genechip. However, according to the present invention, the methods offer the capacity to capture complete set of human exons because long bait probes generated from cDNA templates are used. This substantially reduces operation cost.

In the prior art, tiling or non-tiling probes were spanned to cover the entire gene typically having an gap interval of no more than 10 bps. This is because larger intervals between probes or single probe for a given region will reduce the chances of capturing the entire gene. Assuming an interval for oligo probes of 10 bps, a maximum length of 5 million bps can be captured by the 500 k-probe microarray. By the same analysis, 20 million bps can be captured by the 2 million-probe high-density microarray genechips. This is still short of the 60 million bps needed to be captured for the entire set of human exons. Either interval requirement has to be relaxed or the capture of entire exome has to be accomplished by using multiple oligo high-density microarrays. These solutions will either reduce the chances of efficient capture or significantly increases the cost of operations. For the most popular 500 k microarrays currently on the market, 10-12 genechips are needed to capture the complete set of human exons.

In contrast, a typical genechip arrayer (e.g., OmniGrid Arrayer OGR-03 manufactured by Genomics Solutions) can spot at least 80,000 spots on regular glass slides. On average, each human gene will have more than one spots on the glass slide since total number of human genes is estimated to be about 30,000. Therefore, the invention enables the capacity for capturing all human exons by using a single hybridization array spotted on a single glass slides. This coverage capacity is not achieved by using more probes, but by using longer and/or full-length DNA probes.

(5). It is known that non-uniform captures were generated by oligo probes spotted on high-density microarrays. However, according to the present invention, the methods offer flexibility to solve this problem.

Recently published papers all acknowledge that unevenness in the capture is a big hurdle for the effective utilization of the next-generation sequencing platforms (Porreca et al., 2007) and (Albert et al., 2007; Porreca et al., 2007). However, according to the present invention, the relative capture efficiency can be adjusted to ensure a more uniform capture across all gene targets. This is achieved by adjusting relative proportion of genes to be placed in the array layout. By increasing the probe numbers for the exons and genomic regions that consistently show weaker capture efficiency, uniformity in capture can be adjusted and improved.

In sum, the present invention, among other things, recites a method that utilizes the hybridization DNA and RNA probes generated from template DNA clones to selectively capture and amplify all exons, or any subsets of exons, or any other desired regions of genomic, mitochondria and other forms of DNA from any biological species including animalia, plantae, fungi, protista, archaea and eubacteria.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### LIST OF REFERENCES

Albert T J, Molla M N, Muzny D M, Nazareth L, Wheeler D, Song X, Richmond T A, Middle C M, Rodesch M J, Packard C J, Weinstock G M, Gibbs R A (2007) Direct selection of human genomic loci by microarray hybridization. Nat Methods 4:903-905.
Cutler D J, Zwick M E, Carrasquillo M M, Yohn C T, Tobin K P, Kashuk C, Mathews D J, Shah N A, Eichler E E, Warrington J A, Chakravarti A (2001) High-throughput variation detection and genotyping using microarrays. Genome research 11: 1913-1925.
Gnirke A, Melnikov A, Maguire J, Rogov P, LeProust E M, Brockman W, Fennell T, Giannoukos G, Fisher S, Russ C, Gabriel S, Jaffe D B, Lander E S, Nusbaum C (2009) Solution hybrid selection with ultra-long oligonucleotides for massively parallel targeted sequencing. Nature biotechnology 27:182-189.
Margulies E H, Vinson J P, Miller W, Jaffe D B, Lindblad-Toh K, Chang J L, Green E D, Lander E S, Mullikin J C, Clamp M (2005) An initial strategy for the systematic identification of functional elements in the human genome by low-redundancy comparative sequencing. Proceedings of the National Academy of Sciences of the United States of America 102:4795-4800.
Okou D T, Steinberg K M, Middle C, Cutler D J, Albert T J, Zwick M E (2007) Microarray-based genomic selection for high-throughput resequencing. Nat Methods 4:907-909.
Porreca G J, Zhang K, Li J B, Xie B, Austin D, Vassallo S L, Leproust E M, Peck B J, Emig C J, Dahl F, Gao Y, Church G M, Shendure J (2007) Multiplex amplification of large sets of human exons. Nat Methods.
Stephens M, Sloan J S, Robertson P D, Scheet P, Nickerson D A (2006) Automating sequence-based detection and genotyping of SNPs from diploid samples. Nature genetics 38:375-381.

What is claimed is:

1. A method for selectively capturing and/or amplifying exons or targeted genomic regions from biological samples, comprising the steps of:
(a) obtaining DNA templates for the targeted genomic regions;
(b) cloning the DNA templates into cloning vectors to form template DNA clones;
(c) constructing libraries of the template DNA clones that cover at least the targeted genomic regions;
(d) generating hybridization probes from the DNA template clones in the libraries;
(e) capturing the targeted genomic DNA regions by hybridizing with the targeted genomic DNA fragments with the generated hybridization probes; and
(f) eluting the captured genomic regions by using conditions for releasing the bound DNA from the hybridization probes.

2. The method of claim 1, wherein the DNA templates are obtained by reverse transcriptions from total RNA or mRNA from the biological sample.

3. The method of claim 1, wherein the DNA templates are obtained by performing multiplex polymerase chain reactions (PCRs), or by gene synthesis.

4. The method of claim 1, wherein the DNA templates are generated for predetermined segments of mitochondria DNA, or the entire mitochondria DNA.

5. The method of claim 1, wherein the cloning step comprises the step of ligating the DNA templates into a cloning vector or plasmid.

6. The method of claim 1, wherein depending on the starting RNA materials, the libraries for the clones of the template DNA probes represent full-length RNA, open-reading frame RNA, or partial-length cDNA of the genes expressed by the biological samples.

7. The method of claim 1, wherein the libraries of the template DNA clones represent the intron regions of interest, when the intron regions are amplified by multiple PCRs or by gene synthesis.

8. The method of claim 1, wherein the template DNA clones in the libraries made from cDNA reverse transcriptions or PCR reactions are used to capture exons of the biological samples, wherein the template DNA clones in the libraries made from multiplex PCRs amplifying intron regions are used to capture intron regions of the biological samples, and wherein the template DNA clones in the libraries made from mitochondria DNA are used to capture mitochondria DNA of the biological samples.

9. The method of claim 1, wherein the template DNA clones in the libraries are organizeable in a format that is manipulable by a robotic system.

10. The method of claim 1, wherein the information of the template DNA clones is stored in a computerized database, the information including at least identity, sequence conformation, manufacturing date and location of each clone.

11. The method of claim 1, where the constructing step comprises the steps of:
(a) examining the quality and the completeness of the template DNA clones in the libraries; and
(b) monitoring and maintaining the quality of the template DNA clones in the libraries for long-term uses.

12. The method of claim 11, wherein the examining step comprises the step of:
(a) confirming the DNA sequence of each clone in the libraries; and
(b) comparing the DNA sequences of the clones with the reference DNA sequences of targeted genes or targeted genomic regions of the biological sample so as to check the completeness of the clones in the libraries.

13. The method of claim 1, wherein the hybridization probes are generated by releasing DNA fragments hosted in the cloning vectors or plasmids with the use of restriction enzymes to digest the template DNA fragments/probes out of the cloning vectors or plasmids.

14. The method of claim 1, wherein the hybridization probes are generated by PCR amplifications using the common primer pair sequences contained in the cloning vectors or plasmids in multiple cloning sites.

15. The method of claim 1, wherein the hybridization probes are generated by using the cloning vectors or plasmids directly, without enzymatically cutting the hybridization probes out or PCR amplify the DNA fragments.

16. The method of claim 1, wherein the hybridization probes are generated by in vitro transcriptions from DNA template clones.

17. The method of claim 1, wherein the hybridization probes are generated by obtaining cDNA or cRNA of the genes by using in vitro reverse transcriptions of the templates DNA in the libraries.

18. The method of claim 1, wherein the capturing step comprises the step of fixing the hybridization probes on surfaces of a solid supporting material or mixing the hybridization probes in a solution.

19. The method of claim 18, wherein the conditions include changes of temperature, changes of salt solution, or changes of pH of solutions.

20. A method for selectively capturing and/or amplifying targeted genomic regions from a biological sample, comprising the steps of:
(a) providing libraries of template DNA clones that cover at least the targeted genomic regions;
(b) generating hybridization probes from the DNA template clones in the libraries; and
(c) capturing the targeted genomic DNA regions by hybridizing the targeted genomic DNA regions with the generated hybridization probes.

21. The method of claim 20, wherein the providing step comprises the steps of:
(a) obtaining DNA templates for the targeted genomic regions;
(b) cloning the DNA templates into cloning vectors to form template DNA clones;
(c) constructing libraries of the template DNA clones that cover at least the targeted genomic regions; and
(d) examining the quality and the completeness of the template DNA clones in the libraries.

22. The method of claim 20, wherein further comprising the step of:
(a) eluting the captured genomic regions by using conditions for releasing the bound DNA from the hybridization probes.

23. The method of claim 20, wherein the targeted genomic regions comprises exons, subsets of exons, or desired regions of genomic, mitochondria and other forms of DNA from the biological sample including animalia, plantae, fungi, protista, archaea and/or eubacteria.

24. A kit for capturing and/or amplifying targeted genomic regions from a biological sample, comprising:
(a) libraries of template DNA clones that cover at least the targeted genomic regions, wherein the template DNA clones are formed by cloning the DNA templates obtained from the targeted genomic regions into cloning vectors;
(b) hybridization probes generated from the DNA template clones in the libraries; and
(c) means for hybridizing the targeted genomic DNA regions with the generated hybridization probes so as to capture the targeted genomic DNA regions.

25. The kit of claims 24, wherein the hybridizing means comprises:
(a) a solid supporting material having one or more surfaces on which the hybridization probes are placed for hybridization of the hybridization probes and the targeted genomic DNA regions; or
(b) a solution with which the hybridization probes are mixed for hybridization of the hybridization probes and the targeted genomic DNA regions.

26. The kit of claim 24, wherein the libraries of the template DNA clones are managed manually, or managed by a spreadsheet program, or stored in a computerized database.

27. The kit of claim 24, further comprising means for eluting the captured genomic regions.

28. The kit of claim 27, further comprising means for detecting the eluted genomic fragments/regions.
